(19) United States
(12) Patent Application Publication
(10) Pub. No.: US 2016/0019084 A1
(43) Pub. Date: Jan. 21, 2016

(54) METHOD AND SYSTEM FOR INTER-CLOUD VIRTUAL MACHINES ASSIGNMENT

(71) Applicant: Eco4Cloud S.r.l., Rende (IT)

(72) Inventors: Agostino Forestiero, Rende (IT); Raffaele Giordanelli, Castiglione Cosentino (IT); Carlo Mastroianni, Cosenza (IT); Giuseppe Papuzzo, Lamezia Terme (IT)

(73) Assignee: ECO4CLOUD S.R.L., Rende (IT)

(21) Appl. No.: 14/501,228

(22) Filed: Sep. 30, 2014

(30) Foreign Application Priority Data
Jul. 18, 2014 (IT) RM2014A000397

(51) Int. Cl. G06F 9/455; H04L 12/911

(52) U.S. Cl. CPC G06F 9/45558; H04L 47/70; G06F 2009/4557; G06F 2009/45595

(57) ABSTRACT

A method is disclosed for providing for a high-level local manager in each data center of a group of data centers. The high-level local manager is configured to allocate a new virtual machine or re-allocate an already running virtual machine. The high-level local managers exchange information with each other and run the same programs or processes, so that each local manager knows where the new virtual machine is to be assigned. Once determined which data center will execute the virtual machine, the method provides for a low-level local manager to assign the virtual machine to one of the servers of the data center according to a local algorithm.

### FIELD OF THE INVENTION

The present invention concerns a method and system for inter-cloud virtual machine assignment.

### BACKGROUND

The ever increasing demand for computing resources has led companies and resource providers to build private warehouse-sized data centers, or to offload applications to the data centers owned by a cloud company. Overall, data centers require a significant amount of power to be operated. The total electricity demand of data centers increased by about 56% from 2005 to 2010, and the electricity usage accounted for about 1.5% of the worldwide electricity usage in 2010, which is comparable to the aviation industry. The financial impact for data center management is also large, since a data center spends between 30% to 50% of its operational expense toward electricity. The efficient utilization of resources in these data centers is therefore essential to reduce costs, energy consumption, carbon emissions, and to ensure a high quality of service to users.

Virtualization technology allows multiple Virtual Machines (VMs) to be run on the same physical server. Although this helps to increase the efficiency of data centers, the optimal distribution of the applications to servers is still an open problem, especially in large and dynamic systems. The problem is even more complex in geographically distributed data centers, whose adoption is rapidly increasing. They are deployed by major cloud service providers, such as Amazon®, Google®, and Microsoft®, to match the increasing demand for resilient and low-latency cloud services, or to interconnect heterogeneous data centers owned by different companies, in the so-called “inter-cloud” scenario. In such environments, data centers offer different and time-varying energy prices, and workload variability is experienced both within single sites and across the whole infrastructure.

The dynamic migration of the workload among data centers has become an opportunity to improve several aspects: better resiliency and failover management, improved load balancing, and exploitation of the “follow the moon” paradigm, i.e., move the workload where the energy is cheaper/cleaner and/or cooling costs are lower. Inter-site migration is enabled by the availability of higher network capacity, thanks to both physical improvements (e.g., through techniques such as wavelength division multiplexing) and logical/functional enhancements (e.g., the adoption of software defined networks). Reliable and low-latency connections can be used to shift a significant amount of the workload from one site to another through dedicated networks or regular Internet connections.

Nonetheless, these advancements do not reduce the complexity of the involved issues, among which: determine whether the benefits of workload migrations may overcome the drawbacks, from which site and to which site to migrate, what specific portion of the workload should be migrated, how to reassign the migrating workload in the target site, etc. Some significant efforts have been done in this area. The electricity price variation, both across time and location, is exploited to reduce overall costs using different strategies, among which: the Stratus approach (“Stratus: Load balancing the cloud for carbon emissions control” by Doyle et al.) exploits Voronoi partitions to determine to which data center requests should be routed; the algorithm proposed by Mehta et al. (“Energy cost management for geographically distributed data centres under time-variable demands and energy prices”) assigns virtual machines to servers using a constraint programming approach; Ren et al. (“Provably-efficient job scheduling for energy and fairness in geographically distributed data centers”) use an online scheduling algorithm based on Lyapunov optimization techniques. Other algorithms address the problem by considering the user's point of view, and aim to choose the most convenient data center to which the user should consign a service or VM.

However, the cited approaches, as well as many others, aim to solve the optimization problem as a whole, in a centralized fashion, undergoing the risk of originating two main issues: (i) algorithms of this kind may be poorly scalable, both for the number of parameters that they must consider and for the large size of the problem, as it may involve tens of thousands of servers; and (ii) they generally assume that all sites share the same strategy and algorithms, which may hamper their autonomy. The need for autonomous management is self-explanatory in multi-owned data centers, and is crucial even within a single-owner infrastructure, for example in the case that one or several sites are the former asset of an acquired company, or are hosted by co-located multi-tenant facilities. A self-organizing hierarchical architecture has been proposed by Feller et al. (“A scalable and autonomic virtual machine management framework for private clouds”), but it is limited to the management of a single data center.

It is an object of the present invention to present a method and system that solves the problems and overcomes the drawbacks of the prior art.

### SUMMARY

The present invention concerns a method that provides a high-level local manager in each data center of a group of data centers, which are committed to allocate a new virtual machine or re-allocate an already running virtual machine. The high-level local managers exchange information with each other and run the same programs or processes, so that each one knows where the new virtual machine is to be assigned. Once determined which data center will allocate the virtual machine, the method provides for a low-level local manager assigning such a virtual machine to one of the servers of the data centers according to a local algorithm. The invention further concerns a data center and a group of data centers configured to perform the method.

The present invention relates to a method for the assignment of a virtual machine among a plurality of data centers, each data center including a plurality of server computers, the method including the execution of the following steps:

A. Within each data center, providing a manager server computer connected directly or indirectly by a physical communication channel to all the other server computers of the data center;

B. For each data center, acquiring, by the manager server computer, from at least a sensor in the data center, at least a respective quantity representative of the functioning status of the data center;

C. For each data center, acquiring, by the manager server computer, from the plurality of servers of the data center, information relevant to utilization of the same plurality of server computers and obtaining, based on this information and the at least a respective quantity of step B, a set of parameters representative of the data center functioning status and an availability or non-availability of the data center to receive the virtual machine;

D. Communicating, through a telecommunication channel, by each manager server computer, the set of parameters, along with the availability or non-availability, of a data center to the other data center managers;

E. Obtaining, by any data center manager, a value of a function of the set of parameters for each data center having the availability, the function being representative of the degree of availability of a data center;

F. Assigning the virtual machine to the data center having the lowest or largest value of the function or respectively a value of the function under or over a pre-determined threshold;

G. Communicating, by the manager server computer of the data center to which the virtual machine has been assigned, to a local manager process running on a server computer of the data center, instructions as to run the virtual machine;

H. Assigning, by the local manager process of step G, the virtual machine to a specific server computer, on the basis of information collected by the server computers of the data center;

I. Switching, by the local manager process, any server computer, that has no virtual machine running on it, to a low-consuming sleep or deactivated mode.

According to an aspect of the invention, in step E, the value of the function is obtained by the data center manager of the data center wherein the virtual machine has been generated.

According to an aspect of the invention, the local manager is run on the manager server computer.

According to an aspect of the invention, the at least a sensor monitors the overall power usage of the server computers.

According to an aspect of the invention, the at least a sensor monitors the overall power usage of a data center and the power usage of the single server computers in the data center.

According to an aspect of the invention, the set of parameters includes the overall utilization of hardware resources, such as central processing unit (CPU), random access memory (RAM), disk, memory, bandwidth, and the carbon footprint of the data center.

According to an aspect of the invention, the overall utilization of a hardware resource is computed as the total amount of the hardware resource utilized by the server computers divided by the hardware resource capacity in the overall data center.

According to an aspect of the invention, the carbon footprint Cᵢ of the data center is computed by the formula:

Cᵢ=PUEᵢ×min{cₛ|server s is available}

Wherein cₛ is the carbon footprint rate, i.e., carbon emissions per unit of consumed energy, of the server computer s in the data center which is available to accommodate the virtual machine, and PUEᵢ is the Power Usage Effectiveness, which is the ratio between the overall power supplied to data center and the part of the power used for computation as detected by the at least a sensor.

According to an aspect of the invention, the function is a weighted average of each parameter divided by the maximum value of the parameter among the data centers.

According to an aspect of the invention, the function is calculated only for those data centers which have some spare capacity to accommodate virtual machines.

According to an aspect of the invention, any one of the data centers verifies periodically, by executing steps A-E, whether there is an imbalance in the values of the function calculated for the data centers, and in the positive, triggers a migration of virtual machines between data centers.

According to an aspect of the invention, in step C, the availability or non-availability is not provided and in step D, the function is obtained for each data center.

According to an aspect of the invention, if there is in step C no data center available, assigning the virtual machine to the data center wherein the virtual machine generated.

In a data center including a plurality of server computers, one server computer of the plurality of server computers is the manager server computer.

### BRIEF DESCRIPTION OF THE DRAWINGS

The invention will be now described by way of illustration but not by way of limitation, with particular reference to the drawings of the annexed figures, wherein:

FIG. 1 shows a block diagram showing the communications between servers of different data centers;

FIG. 2 shows a block diagram illustrating the relationship between two data centers out of the group of data centers of FIG. 1;

FIG. 3 shows a flow chart illustrating an exemplary embodiment of assigning a VM; and

FIG. 4 shows a block diagram illustrating an example of the internal structure of a server computer.

### DETAILED DESCRIPTION

The invention concerns a hierarchical framework for the distribution and consolidation of the workload on a multi-site platform. The framework allows for integrated and homogeneous management of heterogeneous platforms, but at the same time preserves the autonomy of single sites. It is composed of two layers: at the lower layer, each site adopts its own strategy to distribute and consolidate the workload internally. At the upper layer, a set of algorithms—shared by all the sites—are used to evaluate the behavior of single sites and distribute the workload among them, both at the time that new applications/VMs are assigned and when some workload migration from one site to another is deemed appropriate.

At each site, one server is elected as a point of contact or data center manager (DCM) and periodically sends to other sites' DCMs a number of parameters that summarize the state of the site, possibly including the overall utilization of resources, the efficiency of computation, the energy costs, the amount of carbon dioxide (CO2) emissions, etc. Upon reception of such data from the other sites, the DCM executes the upper layer algorithms to: (i) determine the target data center to which a new application should be assigned; (ii) check if the workload is well-balanced among the different sites, and (iii) trigger migration of applications when needed. This strategy resembles the one used to cope with traffic routing in the Internet, where a single protocol—Border Gateway Protocol—is used to interconnect different Autonomous Systems (ASs), while every AS is free to choose its own protocol—e.g., Routing Information Protocol (RIP) or Open Shortest Path First (OSPF)—for internal traffic management.

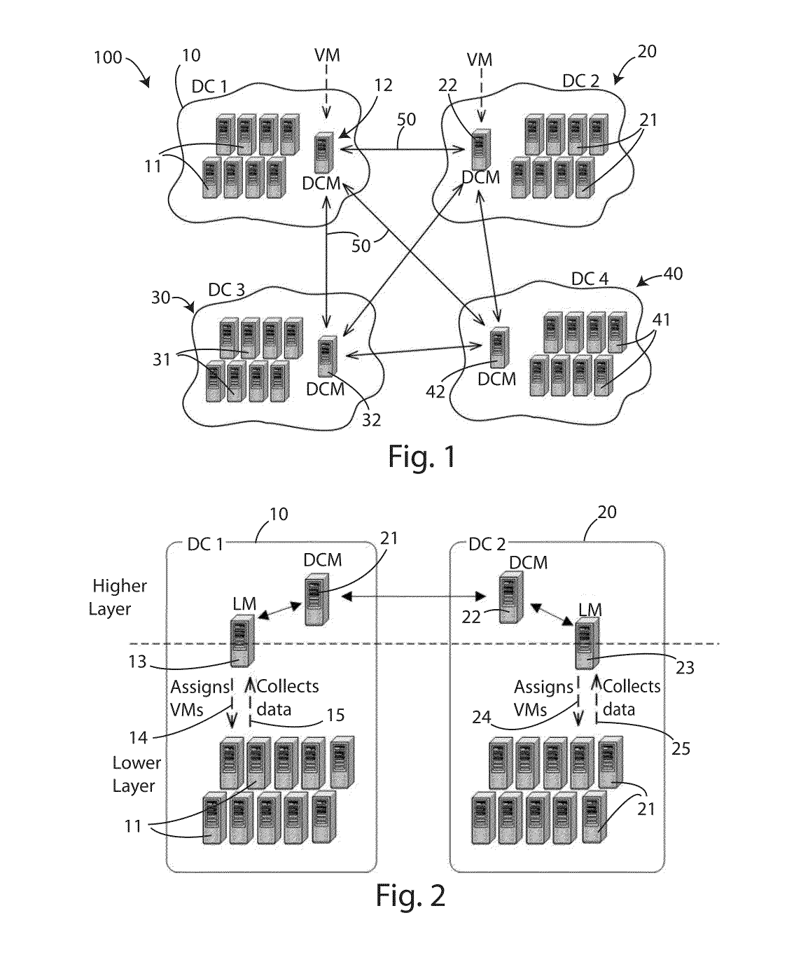

With reference to FIG. 1, four data centers (DC), namely DC1, DC2, DC3, DC4, are depicted, each comprising a data center manager (DCM) run on a server computer among the server computers of the data center. The data center managers are in communication with each other through a physical communication channel in a manner known in the art (telecommunication or computer science).

With reference to FIG. 2, the architecture of the present disclosure is composed of two layers: (i) the upper layer is used to exchange information among the different data centers and drive the distribution of Virtual Machines among the data centers and (ii) the lower layer is used to allocate the workload within single data centers.

The system according to the present disclosure extends the decentralized/self-organizing approach, presented in Mastroianni et al. (“Probabilistic consolidation of virtual machines in self-organizing cloud data centers”) for the consolidation of the workload in a single data center. The single data center solution dynamically consolidates Virtual Machines (VMs) to the minimum number of servers, and allows the remaining servers to enter low consuming sleep modes. In Mastroianni et al., key decisions regarding the local data center are delegated to single servers, which autonomously decide whether or not to accommodate a VM or trigger a VM migration. The data center manager has only a coordination role.

In a similar fashion, at the upper level of the multi-data center architecture according to the present disclosure, most of the intelligence is left to the single data centers DC1, DC2, DC3, DC4, which, for example, decide which information is relevant and should be delivered to other data centers, which portion of the local workload should be migrated elsewhere, etc. Coordinating decisions, for example about the necessity of migrating an amount of workload from one site to another, are taken combining the information related to single data centers.

Beyond decentralization, the system of the present disclosure also features modularity: provided that the interface between the lower and the upper layer is preserved, each layer is free to modify the respective algorithms and their implementation. At the lower layer, each data center is fully autonomous, and can manage the internal workload using either Mastroianni et al., or any other consolidation algorithm. So different data centers can adopt different internal algorithms. On the other hand, the upper layer algorithms may be tuned or modified without causing any impact on the operation of single data centers.

With reference to FIGS. 1 and 2, the system according to the present disclosure shows the following scenario: the DCMs 12, 22, 32, 42 of the different data centers exchange by communications 50 high level information about the state of the local server computers 11, 21, 31, 41. Such information is used, for example, to decide which data center should accommodate a new VM (generated anywhere, e.g., in a specific data center). In particular, four interconnected local data centers 10, 20, 30, 40 are depicted. Each data center elects a single Point of Contact or “DCM,” a program that in the most typical case may be deployed on the same host as the manager of the local virtualization infrastructure, e.g., the vCenter in the case of VMware®. The information possessed by the manager of the local virtualization infrastructure is used by Local Managers (LMs) of the present disclosure. The DCM receives information from the lower layer (through the Local Managers LM 13, 23; only two are depicted in FIG. 2 for the sake of simplicity) and uses it to implement the functionalities of the upper layer. The DCM is required to: (i) communicate by communication 15, 25 with the local data center manager LM to acquire detailed knowledge about the current state of the local data center, for example regarding the usage of host resources and the state of running VMs; (ii) extract relevant high level information about the state of the data center; (iii) transmit/receive such high level information to/from all the other DCMs as above; (iv) execute the algorithms of the upper layer to combine the collected information and take decisions about the distribution of the workload among the data centers. Finally the LM of the chosen DC will assign the VM to a local server by communication 14, 24.

For example, a new VM is generated by a user or machine in a data center and the local DCM is informed about its presence. Thereafter, the assignment algorithm is used to decide to which data center the new VM should be assigned. Once the VM is assigned to the selected data center, this will use the lower layer algorithms to assign the VM to a specific host (server computer).

The framework is designed so that all the DCMs are able to execute the upper layer algorithms and, for example, choose the target DC for a VM originated locally. This requires an all-to-all data transmission among the DCMs, but this is not an issue due to the relatively low number of interconnected sites and the small amount of transmitted data.

Since the single data centers are autonomous regarding the choice of the internal algorithms for workload management, the invention focuses on the algorithms of the upper layer. According to an exemplary embodiment of the present disclosure, at least three algorithms must be executed at each DCM: (i) an assignment algorithm that determines the appropriate target data center for each new VM; (ii) a redistribution algorithm that periodically evaluates whether the current load balance is appropriate and, if necessary, decides whether an amount of the workload should be migrated to/from another site; and (iii) a migration algorithm that determines to which target site or from which source site the workload should be migrated.

The assignment algorithm has the primary role of distributing the workload of new VMs on the basis of a set of objectives decided by the management of the data centers group and pertaining to costs, consumed energy, carbon emissions, load balancing, etc. The other two algorithms in the above list are tailored to the dynamic redistribution of the workload. They share the same objectives of the assignment algorithm, but may take into account additional considerations, among which: the tolerance admitted on the achievement of the objectives, the limits on the frequency of migrations and on the amount of migrated data, the balance between benefits and costs related to migrations, etc. As mentioned above, a key responsibility of the DCM is to analyze detailed data about the local data center and summarize relevant information that is then transmitted to remote DCMs and used for the assignment and redistribution of workload. The nature of the high-level information depends on the objectives that must be achieved. Some important goals are:

1. Reduction of costs. The costs associated with the execution of a given workload depends on many factors, among which the cost of power needed for computation, for cooling and for power distribution, the costs related to staff, server maintenance, etc. An important element to consider is that the cost of electricity is generally different from site to site and also varies with time, even on a hour-to-hour basis; therefore, the overall cost may be reduced by shifting portions of the workload to more convenient sites.

2. Reduction of consumed energy. The amount of consumed energy is generally easier to evaluate than the costs, as modern data centers are equipped with sensors that monitor the power usage in computational resources. The total power may be obtained by multiplying the power consumed for computation by the PUE (Power Usage Effectiveness) index.

3. Reduction of carbon emissions. Companies are strongly encouraged to reduce the amount of carbon emissions, not only to comply with laws and rules, but also to advertise their green effort and attract customers that are increasingly careful about sustainability issues.

4. Quality of service. The workload must be distributed without overloading any single site, as this may affect the quality of the service perceived by users. Moreover, quality of service may be improved by properly combining and assigning applications having different characteristics, for example, CPU-bound and RAM-bound applications.

5. Load balancing. In a multi-DC environment, especially if managed by the same organization, it may be important to balance the load distributed to the different sites. Among the rationales are: a better balance may help improve the responsiveness of the sites, decrease the impact on physical infrastructure—e.g., in terms of cooling and power distribution—to help prevent overload situations.

6. Inter-DC data transmission. In some cases, it is more efficient to assign a VM to the local data center, instead of delivering it to a more convenient remote data center, depending on many factors, among which the amount of data used by the VM, the available inter-DC bandwidth, and the type of applications hosted by the VMs. For example, choosing a local data center is more convenient in the case that the VM hosts a database server, much less if it runs a Web service, especially in the frequent case that Web services are replicated on several data centers.

The goals are not independent from each other. For example, overall costs depend on the consumed power, while a good load balance may help improve the quality of service. All the mentioned goals are important, yet different data centers may focus on different aspects, depending on the specific operating conditions and on the priorities prescribed by the management. The assignment algorithm described in the following is specifically devised for the case in which the two primary objectives are the reduction of overall carbon emissions and load balancing. These two goals are chosen because they are representative of two opposite needs, the need for optimizing the overall efficiency and the need for guaranteeing the fairness among data centers. However, the assignment algorithm can be easily adapted to a different choice of objectives.

For the described scenario, the DCM of each data center collects two kinds of information: the overall utilization of the data center resources, separately computed for each resource type (CPU, RAM, disk, memory, bandwidth, etc.) and the carbon footprint rate of the servers, i.e., carbon emissions per unit of consumed energy. For example, the overall CPU utilization is computed as the total amount of CPU utilized by servers divided by the CPU capacity of the entire data center. A bottleneck resource for a data center is the one with the largest utilization. The carbon footprint rate of a server s, cₛ, is measured in Tons/MWh. The contribution of a server to carbon emissions is computed by multiplying the carbon footprint rate by the energy it consumes. The overall carbon footprint of a data center can then be approximated by summing the contributions of the servers and then multiplying the obtained quantity by the data center PUE, which allows the contribution of the physical infrastructure to be considered. When assigning a VM, the target data center should be chosen so as to minimize the incremental increase of the carbon footprint and at the same time keep/improve the load balance among the data centers. To this aim, a DCM does not need to know the carbon footprint rate of all the servers of remote sites. It only needs to know, per each site, the best available carbon footprint rate, i.e., the minimum rate among the servers that are available to host the VM. If the assignment algorithms of local sites share the same goals, the VM will be assigned to a server with that value of the carbon footprint rate.

Following these considerations, in an example, the assignment algorithm requires that the DCM of a data center i transmits to the others three simple pieces of data: (i) the utilization of the bottleneck resource—denoted as Uᵢ, (ii) the best available carbon footprint rate, and (iii) the data center PUE (Power Usage Effectiveness, which is the ratio between the overall power supplied to data center and the part of the power used for computation). The last two parameters may be combined, and the carbon parameter Cᵢ of a data center i is defined as:

Cᵢ=PUEᵢ×min{cₛ|server s is available} (1)

In a data center, many servers have the same characteristics, for example, the servers included in the same rack/cluster. Therefore, the computation of Cᵢ can be simplified by considering the carbon emission rate of each cluster instead of each server, and by evaluating the “is available” condition (i.e., the condition of a data center being available to accommodate the virtual machine) for entire clusters as well. Knowing the values of Ci and Uᵢ for each remote data center, the DCM can now choose the best target data center for a VM. For each data center i, the DCM can compute a function ƒ_{assign}ⁱ as follows:

$${f}_{assign}^{i} = β \times \frac{{c}_{i}}{{c}^{max}} + ( 1 - β ) \frac{{U}_{i}}{{U}^{max}} \qquad ( 2 )$$

In the expression, values of Cᵢ are normalized with respect to the maximum value C^{max} communicated by the data centers, and the same is done with Uᵢ (U^{max}). The two mentioned goals—reduction of carbon emissions and load balancing—are weighted through a parameter β, having value between 0 and 1. After computing the values of ƒ_{assign}ⁱ for each data center, the VM is assigned to the data center having the lowest value of ƒ_{assign}ⁱ. Depending on the value of β, this may correspond to giving higher priority to the reduction of carbon emissions (values of β closer to 1) or to the fair balance of load (values of β closer to 0).

The following is the pseudo-code used by a data center DCM to choose the target data center, among N_{DC} data centers of the system, for a VM originated locally.

```
function AssignmentAlgorithm(β)
  while VM arrives
    for each remote datacenter DCᵢ
      Request Ci,Ui parameters
    end for
    Cₘₐₓ = Max{Cᵢ | i = 1 . . .N_{DC}}
    Uₘₐₓ = Max{Uᵢ | i = 1 . . .N_{DC}}
    for each DCᵢ : DCᵢ is not full, that is, Uᵢ <U_{Ti}
      ${f}_{assign}^{i} = β \times \frac{{C}_{i}}{{C}^{max}} + ( 1 - β ) \frac{{U}_{i}}{{U}^{max}}$
    end for
    DC_{target} = DCⱼ such that f_{assign}^{j} = min{f_{assign}ⁱ | i = 1 . . .N_{DC}}
    Assign VM to DC_{target}
  end while
end function
```

First, the DCM requests the values of Uᵢ and Cᵢ to all the remote data centers (as an alternative, the values can be transmitted periodically in a push fashion; in both cases, the amount of transmitted information is small). Then, it computes the maximum values of both parameters, for the normalization, and computes the expression (2) for any data center that has some spare capacity, i.e., for which the utilization of the bottleneck resource does not exceed a given threshold U_{Ti}. Finally, the VM is assigned to the resource data center that has the lowest value of ƒ from expression (2). Once assigned and delivered to the target data center, the VM will be allocated to a physical host using the local assignment algorithm. The same algorithm of the present disclosure, or a variant, may be used to determine the target data center of a VM that is being migrated.

Expression (2) can be easily generalized to the cases where more or different objectives are chosen. For example, if there are N parameters, P₁ . . . P_{N} corresponding to N different goals, the expression is:

$${f}_{assign}^{i} = {β}_{1} \times \frac{{P}_{1}^{i}}{{P}_{1}^{max}} + {β}_{2} \times \frac{{P}_{2}^{i}}{{P}_{2}^{max}} + … + {β}_{N} \times \frac{{P}_{N}^{i}}{{P}_{N}^{max}} \qquad ( 3 )$$

Wherein Pₖ^{max} is the maximum of parameter Pₖ for each data center (each DCM receives the values of Pₖ from the other data centers and therefore can calculate the maximum value), with the condition:

β₁+β₂+ . . . +β_{N}=1 (4)

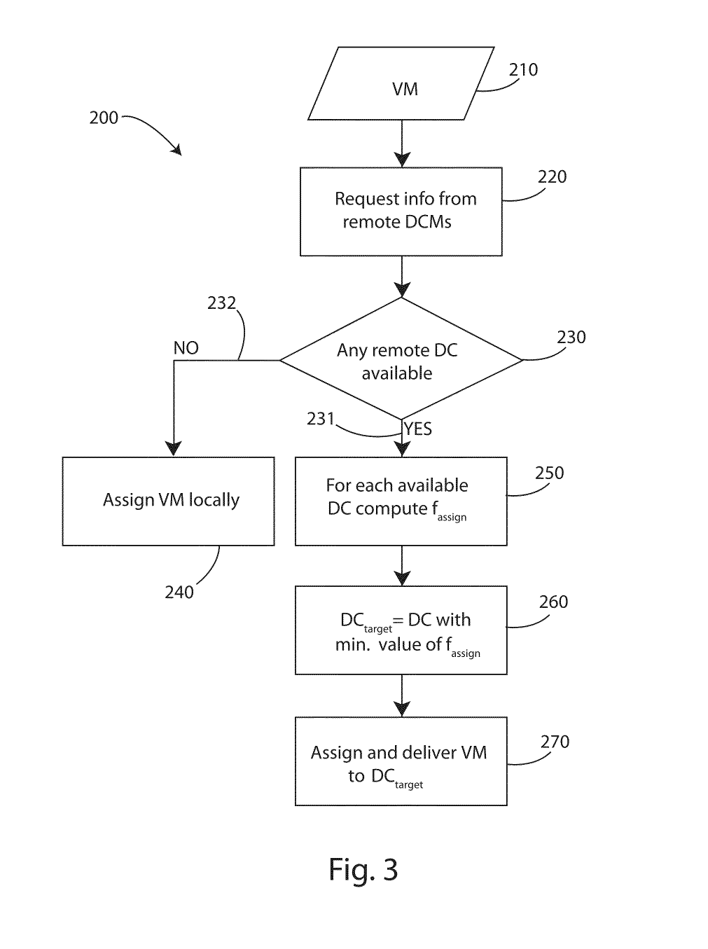

FIG. 3 depicts a flow chart with an example method 200 of the present disclosure, wherein after the generation of a VM to be assigned at 210, the method requests information to remote DCMs at 220. At 230, the method determines whether one or more remote DCs are available. If not, 232, the method assigns the VM locally at 240. If yes, 231, the method computes at 250 the function ƒ_{assign} for each available DC. At 260, the method determines the DC to which the VM is to be assigned, and at 270 the VM is effectively assigned and delivered to such DC.

Now, since a VM is assigned to the DC that has the minimum value of function ƒ, the tendency is that the DCs have equal values of ƒ, or very similar values. However, there can be variations (of the computation load, of the cost of electricity, due to the substitution of the servers, etc.) that can break the equilibrium. Every DC will therefore verify periodically, always collecting the information from the others as above, whether there is an imbalance in the values of ƒ. If there is such an imbalance, the DC with the largest value of ƒ asks for the migration of at least a part of the internal load, for example of the VM of a server, towards another DC (the choice of the load to be migrated is determined by an internal algorithm that is specific to the DC). This load to be migrated is considered by the system as it were a new load and is therefore assigned to a DC with the same VM assignation method as above. The migrations are made until an equilibrium condition is reached again.

It is moreover to be considered that the migrations have a cost, so that before performing them, the system has to assess whether this cost is acceptable or not, i.e., whether the benefits are larger than costs.

It is to be specified that from every function of which one seeks the minimum, another function can be defined with a maximum in place of the minimum. Therefore the invention seeks a minimum or a maximum according to the specific definition of the function. Moreover, in the same way, the invention can also choose a function above or below a certain threshold.

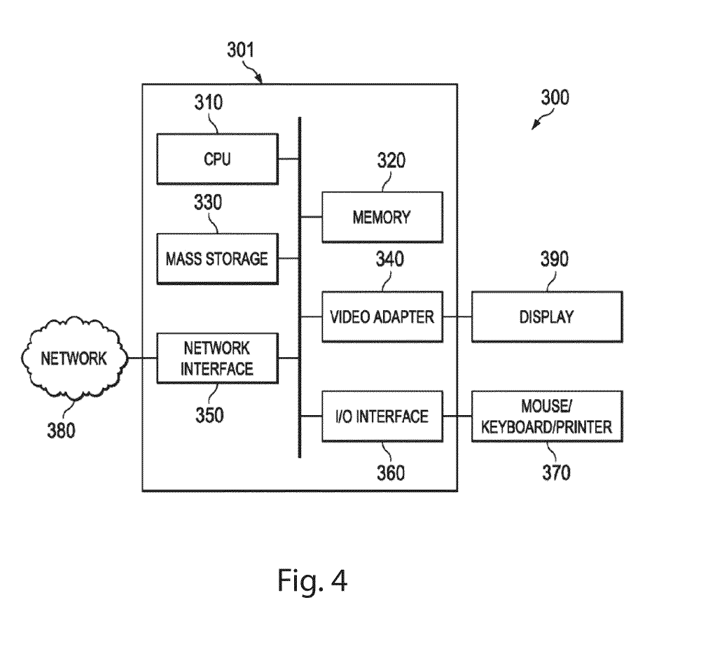

The above method is to be implemented with servers. The specific hardware may vary depending on the situations. FIG. 4 is a block diagram of a server 300 that can be used to implement various embodiments. Specific devices may utilize all of the components shown, or only a subset of the components, and levels of integration may vary from device to device. Furthermore, a device may contain multiple instances of a component, such as multiple processing units, processors, memories, transmitters, receivers, etc. The processing system 300 may comprise a processing unit 301 equipped with one or more input/output devices, such as a speaker, microphone, mouse, touchscreen, keypad, key board, printer, display, and the like. The processing unit 301 may include a central processing unit (CPU) 310, a memory 320, a mass storage device 330, a video adapter 340, and an I/O interface 360 connected to a bus. The bus may be one or more of any type of several bus architectures including a memory bus or memory controller, a peripheral bus, a video bus, or the like.

The CPU 310 may comprise any type of electronic data processor. The memory 320 may comprise any type of system memory such as static random access memory (SRAM), dynamic random access memory (DRAM), synchronous DRAM (SDRAM), read only memory (ROM), a combination thereof, or the like. In an embodiment, the memory 320 may include ROM for use at boot up, and DRAM for program and data storage for use while executing programs. In embodiments, the memory 320 is non-transitory. The mass storage device 330 may comprise any type of storage device configured to store data, programs, and other information and to make the data, programs, and other information accessible via the bus. The mass storage device 330 may comprise, for example, one or more of a solid state drive, hard disk drive, a magnetic disk drive, an optical disk drive, or the like.

The video adapter 340 and the I/O interface 360 provide interfaces to couple external input and output devices to the processing unit. As illustrated, examples of input and output devices include a display 390 coupled to the video adapter 340 and any combination of mouse/keyboard/printer 370 coupled to the I/O interface 360. Other devices may be coupled to the processing unit 301, and additional or fewer interface cards may be utilized. For example, a serial interface card (not shown) may be used to provide a serial interface for a printer.

The processing unit 301 also includes one or more network interfaces 350, which may comprise wired links, such as an Ethernet cable or the like, and/or wireless links to access nodes or one or more networks 380. The network interface 350 allows the processing unit 301 to communicate with remote units via the networks 380. For example, the network interface 350 may provide wireless communication via one or more transmitters/transmit antennas and one or more receivers/receive antennas. In an embodiment, the processing unit 301 is coupled to a local area network or a wide area network for data processing and communications with remote devices, such as other processing units, the Internet, remote storage facilities, or the like.

In the foregoing, some embodiments and variations of the present invention have been disclosed, but it is to be understood that those skilled in the art will be able to make variations and changes, without departing from the scope of the enclosed claims.

What is claimed is:

1. A method for assigning a virtual machine to one of a plurality of data centers, each data center including a plurality of server computers, the method comprising:
providing a manager server computer within each data center, the manager server computer connected directly or indirectly to all the other server computers of the data center;
acquiring at least a respective quantity representative of the functioning status of the data center by the manager server computer in each data center, from at least a sensor in the data center;
acquiring information relevant to utilization of the plurality of server computers by the manager server computer in each data center, from the plurality of servers of the data center;
obtaining a set of parameters representative of the data center functioning status and an availability or non-availability of the data center to receive the virtual machine, based on the utilization information and the at least a respective quantity;
communicating the set of parameters, along with the availability or non-availability of the data center, by each manager server computer to the other data center managers through a telecommunication channel;
obtaining a value of a function of the set of parameters for each data center having the availability by any data center manager, the function being representative of the degree of availability of a data center;
assigning the virtual machine to the data center having a lowest value or a largest value of the function or respectively a value of the function under or over a predetermined threshold;
communicating instructions to run the virtual machine from the manager server computer of the data center to which the virtual machine has been assigned to a local manager process running on a server computer of the data center;
assigning the virtual machine to a specific server computer by the local manager process, on the basis of information collected by the server computers of the data center; and
switching any server computer that has no virtual machine running on it to a low-consuming sleep or deactivated mode, by the local manager process.

2. The method according to claim 1, wherein the value of the function is obtained by the data center manager of the data center where the virtual machine has been assigned.

3. The method according to claim 1, wherein the local manager process is run on the manager server computer.

4. The method according to claim 1, wherein the at least a sensor monitors an overall power usage of the server computers.

5. The method according to claim 4, wherein the at least a sensor monitors the overall power usage of a data center and the power usage of the single server computers in the data center.

6. The method according to claim 1, wherein the set of parameters includes an overall utilization of hardware resources, such as central processing unit, random access memory, disk, memory, bandwidth, or a carbon footprint of the data center.

7. The method according to claim 6, wherein the overall utilization of a hardware resource is computed as a total amount of the hardware resource utilized by the server computers divided by the hardware resource capacity in the overall data center.

8. The method according to claim 6, wherein the carbon footprint Cᵢ of the data center is computed by the formula:
Cᵢ=PUEᵢ×min{cₛ|server s is available}
wherein cₛ is a carbon footprint rate, which is a measure of carbon emissions per unit of consumed energy of the server computer s in the data center which is available to accommodate the virtual machine, and PUEᵢ is a Power Usage Effectiveness, which is a ratio between the overall power supplied to the data center and a part of the power used for computation as detected by the at least a sensor.

9. The method according to claim 1, wherein the function is a weighted average of each parameter divided by a maximum value of the parameter among the data centers.

10. The method according to claim 1, wherein the function is calculated only for those data centers which have some spare capacity to accommodate virtual machines.

11. The method according to claim 1, wherein any one of the data centers periodically verifies whether there is an imbalance in the values of the function calculated for the data centers, and if there is an imbalance, triggers a migration of virtual machines between the data centers.

12. The method according to claim 1, wherein the availability or non-availability of a data center to receive the virtual machine is not provided in the acquired information, and the function is obtained for each data center.

13. A data center, comprising:
a plurality of server computers, wherein one server computer of the plurality of server computers is a manager server computer connected directly or indirectly to all the other server computers of the data center, the manager server computer configured to:
acquire at least a respective quantity representative of the functioning status of the data center from at least a sensor in the data center;
acquire information relevant to utilization of the plurality of server computers from the plurality of server computers;
obtain a set of parameters representative of the data center functioning status and an availability or non-availability of the data center to receive the virtual machine, based on the utilization information and the at least a respective quantity;
communicate the set of parameters, along with the availability or non-availability of the data center to other data center managers in other data centers through a telecommunication channel;
obtain a value of a function of the set of parameters if the data center has the availability, the function being representative of the degree of availability of the data center;
assign a virtual machine to the data center having a lowest value or a largest value of the function or respectively a value of the function under or over a predetermined threshold;
communicate instructions to run the virtual machine to a local manager process running on a server computer of the data center to which the virtual machine has been assigned;
assign the virtual machine to a specific server computer by the local manager process, on the basis of information collected by the server computers; and
switch any server computer that has no virtual machine running on it to a low-consuming sleep or deactivated mode, by the local manager process.

14. A system of data centers, wherein each data center is a data center according to claim 13.
